(19) United States
(12) Patent Application Publication
(10) Pub. No.: US 2013/0020414 A1
(43) Pub. Date: Jan. 24, 2013

(54) SPRAY GUN NOZZLE TIP WITH INTEGRATED SEAL AND AUTO ALIGINING FLUID PATH

(71) Applicants: Scott Thomason, Macedonia, OH (US); Steven C. Cooper, Athens, GA (US)

(72) Inventors: Scott Thomason, Macedonia, OH (US); Steven C. Cooper, Athens, GA (US)

(73) Assignee: SUNLESS, INC., Macedonia, OH (US)

(21) Appl. No.: 13/552,797

(22) Filed: Jul. 19, 2012

Related U.S. Application Data
(60) Provisional application No. 61/510,027, filed on Jul. 20, 2011.

(51) Int. Cl. B05B 1/30; B05B 1/00

(52) U.S. Cl. 239/569; 239/600

(57) ABSTRACT

A nozzle includes a body having a first bore and a first liquid inlet. A liquid tip assembly, including a second bore and second liquid inlet, is inserted into the first bore with the first and second liquid inlets axially aligned. Sealing rings between the liquid tip assembly and first bore define an annular fluid path coupling the first and second liquid inlets. The liquid tip assembly further includes a liquid opening that is sealed by an axially moveable fluid tip positioned in the second bore. A slidable seal is formed between the fluid tip and second bore. A front of the body includes an aperture configured to receive an air cap secured to the body by a retaining ring. The air cap includes an air opening associated with the liquid opening to provide atomizing air. The nozzle may be easily assembled and disassembled from a front of the nozzle.

### PRIORITY CLAIM

This application claims priority from U.S. Provisional Application for Patent No. 61/510,027 filed Jul. 20, 2011, the disclosure of which is hereby incorporated by reference.

### TECHNICAL FIELD

This invention concerns an atomizing spray nozzle and, in particular, a design of such a spray nozzle that supports easy assembly and disassembly for nozzle construction and servicing.

### BACKGROUND

Spray nozzles with metering assemblies are well known in the prior art. Alignment between the parts performing the metering function, as well as those parts performing metering actuation, is essential. Still further, one or more seals are needed around the moving parts performing the metering function. The correct assembly of these parts with proper alignment and installation can be difficult, especially as nozzles decrease in size and increase in part count and functional complexity.

Operation of the spray nozzle will sometimes result in part deterioration and consequent nozzle failure. With more complex and expensive nozzles being used, replacement of a failed or malfunctioning spray nozzle becomes a less attractive solution for users. This necessitates configuration of the nozzle to support servicing with a part repair or replacement, and in particular servicing that can be performed by the user without returning the nozzle to the factory or service center. However, prior art spray nozzles are not known for supporting easy disassembly and reassembly for servicing.

There is a need in the art for a metering spray nozzle design that allows for an easier and more robust method for assembly and servicing of a spray nozzle, and in particular the fluid nozzle tips, metering needles, and metering needle seals of that spray nozzle.

### SUMMARY

In an embodiment, a spray nozzle comprises: a nozzle housing having a first bore and a first liquid inlet passing through the nozzle housing and opening into the first bore; a nozzle liquid tip assembly inserted into the first bore and removably attached to the first bore, the nozzle liquid tip assembly including a liquid tip having a second bore and a second liquid inlet passing through the liquid tip and opening into the second bore; a first annular sealing member positioned between an outer surface of the liquid tip and the first bore at a first location behind both the second liquid inlet and the nozzle housing opening into the first bore; and a second annular sealing member positioned between the outer surface of the liquid tip and the first bore at a second location ahead of both the second liquid inlet and the nozzle housing opening into the first bore; wherein the first and second annular sealing members define an annular fluid path coupling the first liquid inlet to the second liquid inlet.

In an embodiment, a spray nozzle comprises: a nozzle housing having a first bore and a liquid inlet path; a nozzle liquid tip positioned within the first bore; an annular fluid path between the nozzle liquid tip and the nozzle housing and surrounding the nozzle liquid tip, the annular fluid path configured to receive fluid from the liquid inlet path; and the annular fluid path fluidly coupled to a liquid inlet of the nozzle liquid tip.

In an embodiment, a spray nozzle comprises: a nozzle housing having an aperture configured to receive an air cap; an air cap retaining ring configured to removably secure the air cap within the aperture of the nozzle housing; wherein the nozzle housing includes a first bore; and a nozzle liquid tip assembly defining a fluid path, said nozzle liquid tip assembly being removably secured within the first bore; wherein the nozzle liquid tip assembly is removable from the first bore as a self-contained assembly following removal of the air cap retaining ring and air cap.

An advantage of the embodiments is that the nozzle liquid tip assembly is removable from the front of the spray nozzle.

### BRIEF DESCRIPTION OF THE DRAWINGS

A more complete understanding of the invention may be obtained by reference to the Detailed Description herein, taken in conjunction with the figures:

FIG. 1 is a cross-sectional view of a nozzle assembly in a valve closed position;

FIG. 2 is an exploded isometric view of the air cap and air cap retainer disassembled from the nozzle assembly;

FIG. 3 is an exploded isometric view of the nozzle liquid tip assembly disassembled from the nozzle assembly;

FIG. 4 is an exploded isometric view of the liquid metering needle disassembled from the nozzle assembly;

FIG. 5 is an isometric view of the nozzle liquid tip assembly, liquid metering needle, liquid metering tip base, needle actuator pin, and needle return spring;

FIGS. 6A and 6B are isometric views of the nozzle liquid tip assembly;

FIGS. 7A and 7B are plan and cross-section views, respectively, of the nozzle liquid tip assembly;

FIG. 8 is an exploded isometric view of the nozzle liquid tip assembly;

FIG. 9 is a cross-sectional view of a nozzle assembly in a valve open position; and

FIG. 10 is a cross-sectional view of a nozzle assembly taken through the annular fluid path.

### DETAILED DESCRIPTION OF THE DRAWINGS

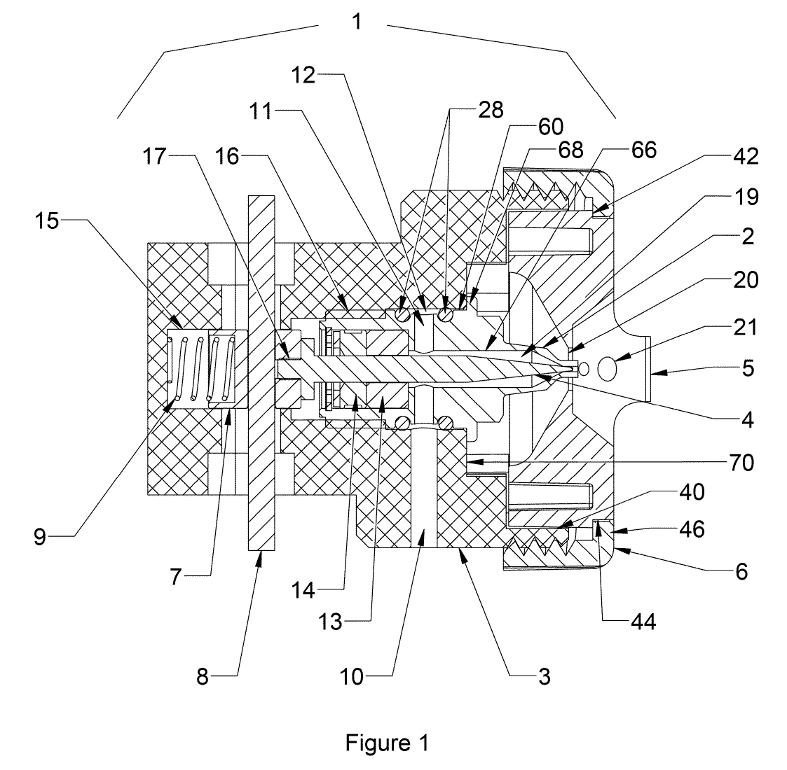

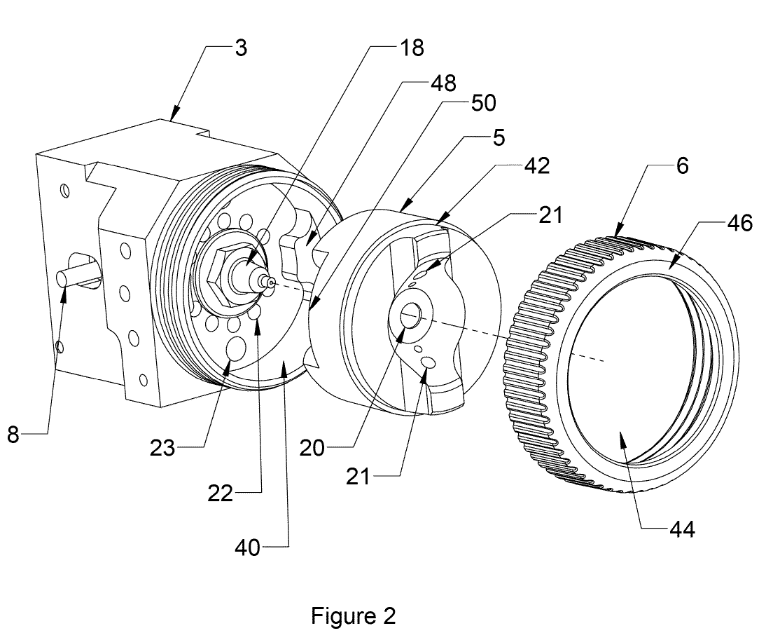

Reference is now made to FIG. 1 which shows a cross-sectional view of a spray nozzle assembly 1. The nozzle assembly 1 includes a nozzle housing 3, an air cap 5, and an air cap retainer 6. An outside circumferential surface at the front end of the nozzle housing 3 is threaded to mate with a correspondingly threaded inside circumferential surface of the air cap retainer 6. The front end of the nozzle housing 3 further includes an aperture 40 configured to receive the air cap 5. A front of the air cap 5 is shaped to include a circumferential step 42. The air cap retainer 6 includes a central aperture 44 defining a shoulder 46. The shoulder 46 engages the step 42 when the air cap retainer 6 is installed at the front end of the nozzle housing 3 to retain the air cap 5 within the aperture 40 of the nozzle housing 3. The front of the air cap 5 is exposed through the central aperture 44 of the air cap retainer 6 as shown in FIG. 2. Thus, it will be noted that the air cap 5 can be removed from the nozzle assembly 1, for cleaning or replacement, for example, by simply un-screwing the air cap retainer 6.

With additional reference now to FIG. 2, the aperture 40 of the nozzle housing 3 includes at least one protrusion 48. The protrusion 48 is formed at the base of the aperture 40. The air cap 5 further includes at least one notch 50 formed in its back end and outer circumference. The protrusion 48 and notch 50 are similarly sized and shaped to mate with each other when the air cap 5 is installed in the front end aperture 40 of the nozzle housing 3.

The air cap 5 further includes an air cap atomizing port 20. Air for forming an atomized spray is emitted from port 20.

The mating between the protrusion 48 and notch 50 prohibits rotation of the air cap 5 within the aperture 40, and thus ensures a desired orientation and alignment of the installed air cap 5 relative to the nozzle housing 3 and the nozzle assembly 1. This alignment is important to ensure a correct atomized spray pattern from the nozzle assembly 1. In this regard, the air cap 5 includes a plurality of air cap pattern shaping ports 21. These ports 21 permit pattern shaping air to assist, in a manner known to those skilled in the art, in the shaping of the atomized spray emitted from about port 20 by the nozzle assembly 1. The position of the ports 21 is fixed relative to the position of the notch 50 formed in the back end and outer circumference of the air cap 5, and thus the position of the ports 21 will also be fixed relative to the nozzle housing 3 and the nozzle assembly 1 when the air cap 5 is installed in the end of the nozzle housing 3.

It will be understood that desired orientation and alignment supported by the mating between the protrusion 48 and notch 50 can be any desired orientation and alignment associated with spray operation. In one desired orientation and alignment, the plurality of air cap pattern shaping ports 21 will receive air for operation for pattern shaping. In another desired orientation and alignment, the plurality of air cap pattern shaping ports 21 will not receive air and thus no pattern shaping operation is performed. In yet another desired orientation and alignment, the orientation and alignment function of the protrusion 48 and notch 50 is indexed so as to control an amount of air that the plurality of air cap pattern shaping ports 21 receive. To accomplish these operations, it will be understood that plural protrusions 48 and/or notches 50 may be provided.

The removal of the air cap 5 further gives access to the nozzle housing atomizing air paths 22 and nozzle housing pattern shaping air paths 23 at the bottom of the aperture 40 formed at the front end of the nozzle housing 3. This permits cleaning and other maintenance tasks to be performed on the paths 22 and 23. The nozzle housing atomizing air paths 22 provide air that is delivered to the air cap atomizing port 20 in accordance with the desired orientation and alignment supported by the mating between the protrusion 48 and notch 50 for use in forming the atomized spray by means of air-assisted atomization of a fluid delivered through a nozzle liquid tip 2 (see, FIG. 1) present in the port 20. The nozzle housing pattern shaping air paths 23 provide air that is delivered to the air cap pattern shaping ports 21 for use in shaping a pattern of the atomized spray emitted from the nozzle. Through use of the mating protrusion 48 and notch 50 discussed above, the outlet for the nozzle housing pattern shaping air paths 23 in the nozzle housing 3 will be properly aligned with the location of the air cap pattern shaping ports 21 in the air cap 5.

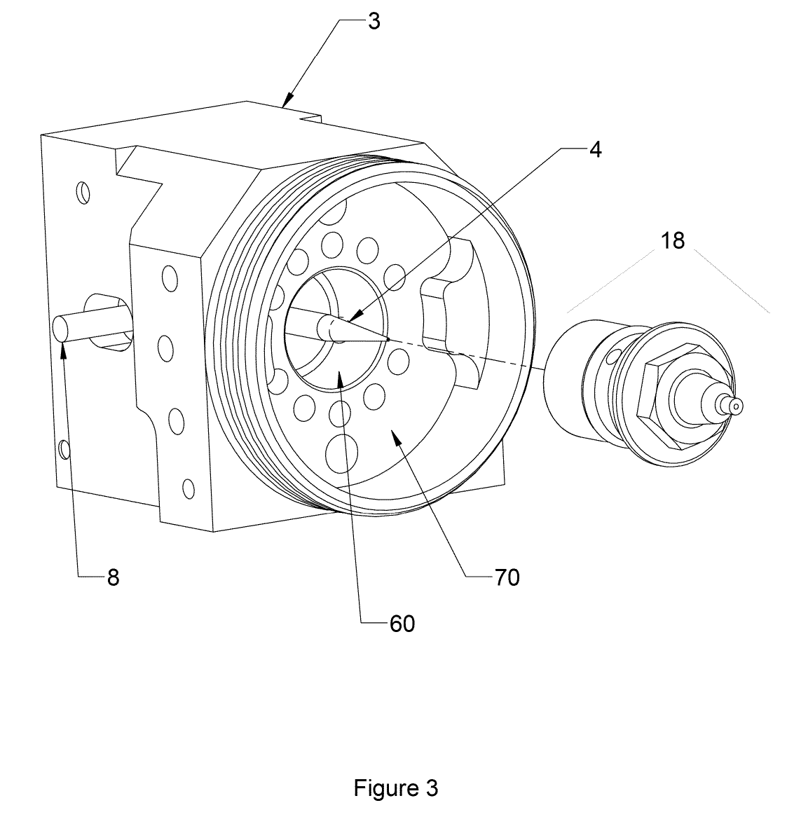

The removal of the air cap 5 further gives access to the nozzle liquid tip assembly 18. The nozzle liquid tip assembly 18 includes the nozzle liquid tip 2. The nozzle liquid tip assembly 18 can be removed from the nozzle assembly 1 (and specifically from within a central bore 60 in the nozzle housing 3, said central bore being coaxially aligned with the opening in the front end of the housing 3), for cleaning or replacement, for example, after un-screwing the air cap retainer 6 and removing the air cap 5. This is shown by FIG. 3 which illustrates an exploded isometric view of the nozzle liquid tip assembly 18 removed from the nozzle assembly 1. The term “central” does not necessarily imply or require the bore 60 to be centered in the nozzle housing 3. The nozzle liquid tip assembly 18 is retained in the central bore 60 by any suitable means. In a preferred implementation this retention is accomplished through correspondingly threaded surfaces (generally indicated at reference 16 in FIG. 1) on the outer surface of the nozzle liquid tip assembly 18 and surface of the central bore 60 in the nozzle housing 3. The front end of the nozzle liquid tip assembly 18 is positioned, when the nozzle liquid tip assembly 18 is installed in the central bore 60 in the nozzle housing 3, in alignment with the air cap atomizing port 20.

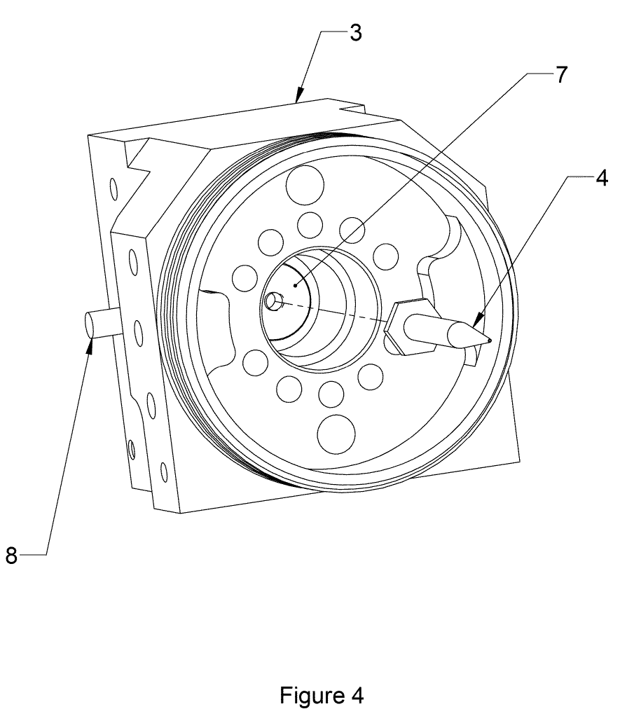

As shown in FIG. 3, the removal of the nozzle liquid tip assembly 18 further gives access to a liquid metering needle 4. The liquid metering needle 4 can be removed from the nozzle assembly 1 (and specifically from within the central bore in the nozzle housing 3), for cleaning or replacement, for example, after un-screwing the air cap retainer 6 and removing the air cap 5 and nozzle liquid tip assembly 18. This is shown by FIG. 4 which illustrates an exploded isometric view of the liquid metering needle 4 removed from the nozzle assembly 1. The liquid metering needle 4 is retained in the central bore 60 by any suitable means. In a preferred implementation this retention is accomplished through correspondingly threaded surfaces (generally indicated at reference 17 in FIG. 1) on the outer surface of the liquid metering needle 4 and an opening in a liquid metering tip base 7.

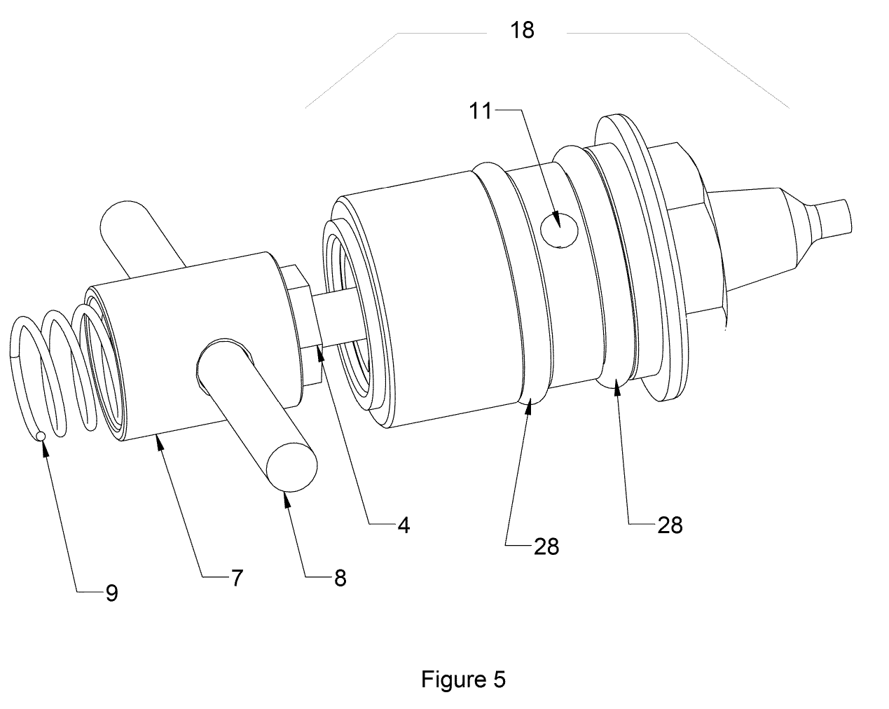

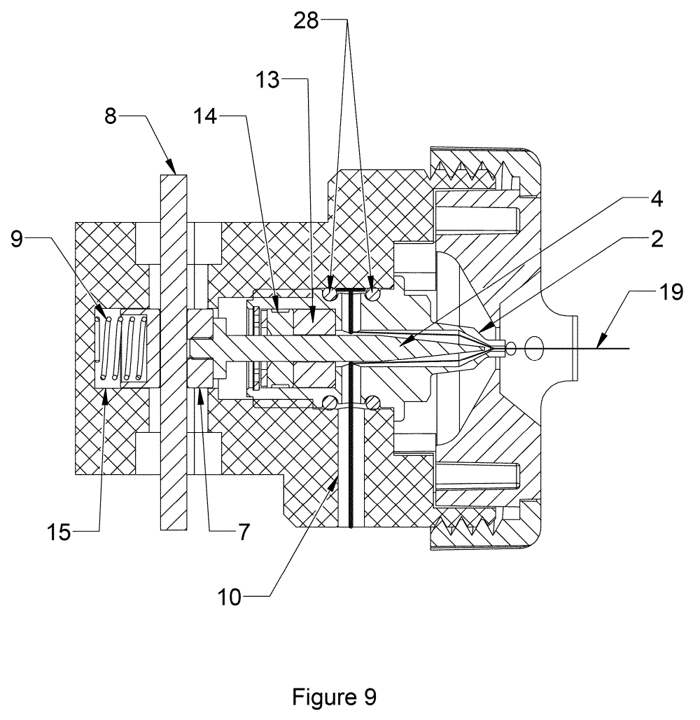

Reference is now made to FIG. 5 which shows an isometric view of the nozzle liquid tip assembly 18 and its relationship to the liquid metering needle 4 and liquid metering tip base 7. FIG. 5 further shows the actuating mechanism for the liquid metering operation. The actuating mechanism includes a needle actuator pin 8 coupled to the liquid metering tip base 7 and needle return spring 9. FIG. 1 shows the actuating mechanism installed within the nozzle housing 3. The liquid metering needle 4 is attached to the liquid metering tip base 7. Movement of the needle actuator pin 8 will cause a corresponding movement of the liquid metering needle 4 relative to the nozzle liquid tip assembly 18. For example, movement of the needle actuator pin 8 backward (i.e., in a direction away from the nozzle liquid tip assembly 18) will cause the liquid metering needle 4 to also move backward and, with reference to FIG. 9, this will withdraw the end of the liquid metering needle 4 from the opening at the end of the nozzle liquid tip 2 permitting liquid present within the nozzle liquid tip assembly 18 to pass for output from the opening of the nozzle liquid tip 2 along path 19. Conversely, movement of the needle actuator pin 8 forward (i.e., in a direction towards the nozzle liquid tip assembly 18) will cause the liquid metering needle 4 to also move forward and, with reference to FIG. 1, this will insert the end of the liquid metering needle 4 into the opening at the end of the nozzle liquid tip 2 forming a seal to prevent liquid present within the nozzle liquid tip assembly 18 from passing for output from the opening of the nozzle liquid tip 2. The liquid metering needle 4 accordingly functions as a valve mechanism with respect to the flow of liquid through the opening at the end of the nozzle liquid tip 2. In a preferred implementation, a force is applied to needle actuator pin 8 with respect to an actuation for backward movement. The needle return spring 9 provides a biasing return force opposing the backward movement of the needle actuator pin 8. The spring 9 is retained in a needle base guide pocket 15 that is coaxially aligned with the central bore 60 of the nozzle housing 3.

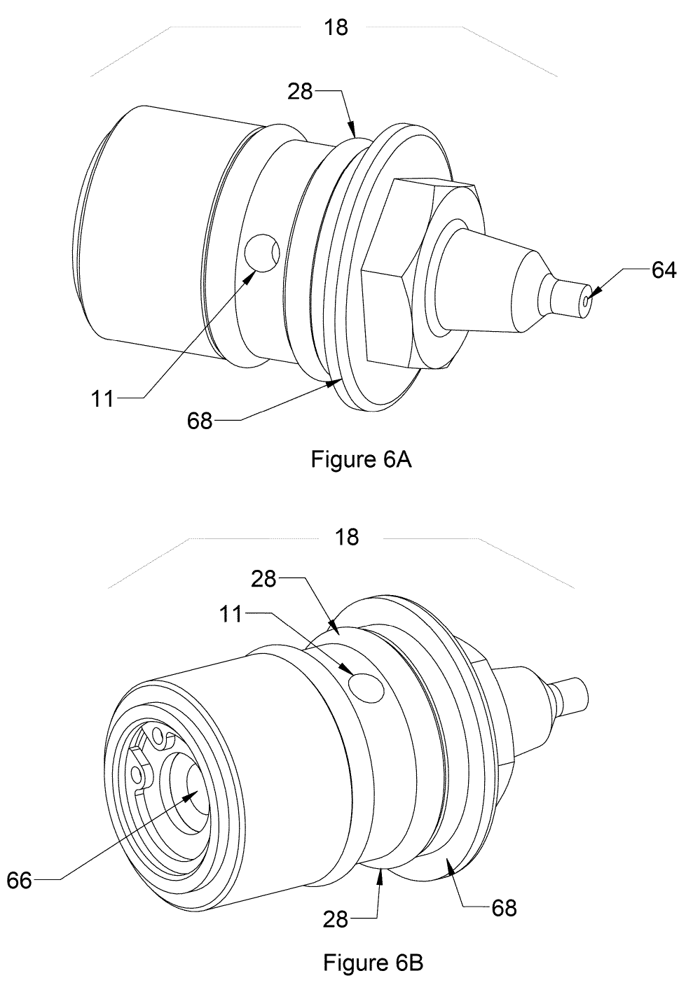

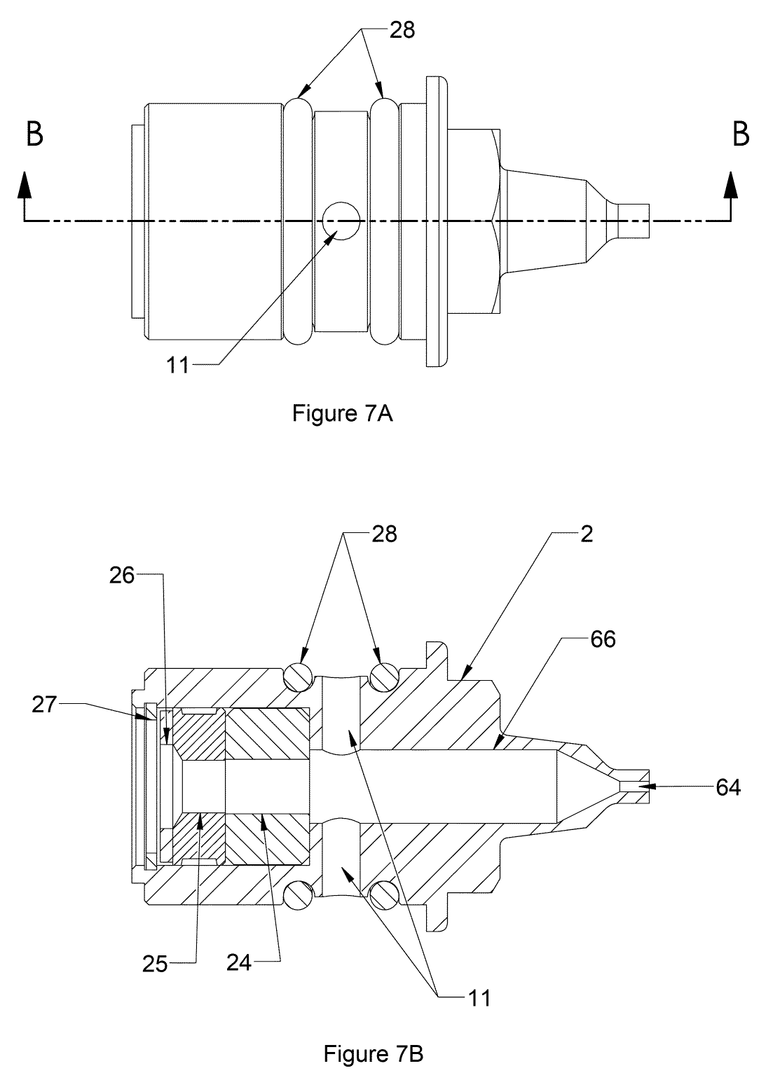

Reference is now made to FIGS. 6A and 6B which are isometric views of the nozzle liquid tip assembly 18, and to FIGS. 7A and 7B which are plan and section views, respectively, of the nozzle liquid tip assembly 18.

FIGS. 6A and 7B show the nozzle liquid tip 2 of assembly 18 with its opening 64 at a front end. As shown in FIG. 1, this opening 64 is sealed by the end of the liquid metering needle 4 to form a liquid valve. The liquid metering needle 4 is inserted at a back end of the assembly 18 into a central bore 66 of the nozzle liquid tip 2. The central bore 66 tapers towards the front end where the opening 64 is formed. Again, the term “central” does not necessarily imply or require the bore 66 to be centered in the nozzle liquid tip 2.

A shoulder portion 68 is provided on the outer circumference of the nozzle liquid tip 2 to rest against the base surface 70 of the aperture 40 formed at the end of the nozzle housing 3. This shoulder portion 68 functions to stop further insertion of the nozzle liquid tip assembly 18 into the central bore 60 in the nozzle housing 3. See, FIGS. 1 and 2. This is important so as to properly position in an axial manner the nozzle tip liquid port 11 which passes through the nozzle liquid tip 2 relative to the liquid inlet port 10 which passes through the nozzle housing 3. For reasons discussed below, there is no concern in this implementation with the angular orientation of the nozzle liquid tip ports 11. It is however important to control the axial placement and positioning of the nozzle liquid tip 2, and in particular the nozzle tip liquid port 11, relative to the liquid inlet port 10.

A pair of nozzle liquid tip o-rings 28 are situated in annular grooves formed in the outer surface of the nozzle liquid tip 2, the grooves being positioned forward of and backward of, respectively, the nozzle tip liquid port 11. When the nozzle liquid tip 2 is inserted into the central bore 60 in the nozzle housing 3, the nozzle liquid tip o-rings 28 define an annular liquid path 12 (see, FIG. 1) that permits liquid provided to the nozzle assembly 1 through the liquid inlet port 10 to pass through the nozzle liquid tip ports 11 and enter the fluid exit path 19 within the central bore 66 of the nozzle liquid tip 2. The axial positioning issue is thus that it is important, when axially positioning the nozzle liquid tip 2 within the central bore 60 of the housing 3, that the annular liquid path 12 with its nozzle tip liquid port 11 be axially positioned to align with the positioning of the liquid inlet port 10. The o-rings 28 accordingly serve at least two purposes: first they keep any liquid from leaking out of the nozzle assembly 1, and second they form the annular channel path 12 between the nozzle liquid tip 2 and the inner bore of the nozzle housing 3. This annular channel path 12 will guide incoming liquid from the liquid inlet port 10 into the nozzle tip liquid port 11 of the nozzle liquid tip 2 regardless of the angular orientation of the nozzle tip liquid port 11 relative to the liquid inlet port 10. Thus, when installing the nozzle liquid tip assembly 18 into the central bore 60 in the nozzle housing 3, there is no need for the installer to be concerned with aligning the nozzle tip liquid port 11 to the liquid inlet port 10. Release of the liquid within the fluid exit path 19 is controlled, as discussed above, by the valve action of the liquid metering needle 4.

FIGS. 1 and 7B show a needle liquid seal 25 which functions to slidably seal against an outer surface of the liquid metering needle 4 and statically seal against the central bore 66 of the nozzle liquid tip 2. The needle liquid seal 25 accordingly seals against the outer surface of the metering needle 4 shaft to prohibit liquid from leaking out the back side of the nozzle tip 2. The needle liquid seal 25, nozzle liquid tip o-rings 28 and liquid metering needle 4 function, in combination with each other, to prevent fluid received from the liquid inlet port 10 from leaking out from within the central bore 66 of the nozzle liquid tip 2. Indeed, the only release of that fluid is a controlled valve release due to the withdrawal of the liquid metering needle 4 from the opening 64 in the nozzle liquid tip 2. The needle liquid seal 25 and nozzle liquid tip o-rings 28 serve to prevent leakage through the central bore 60 in the nozzle housing 3.

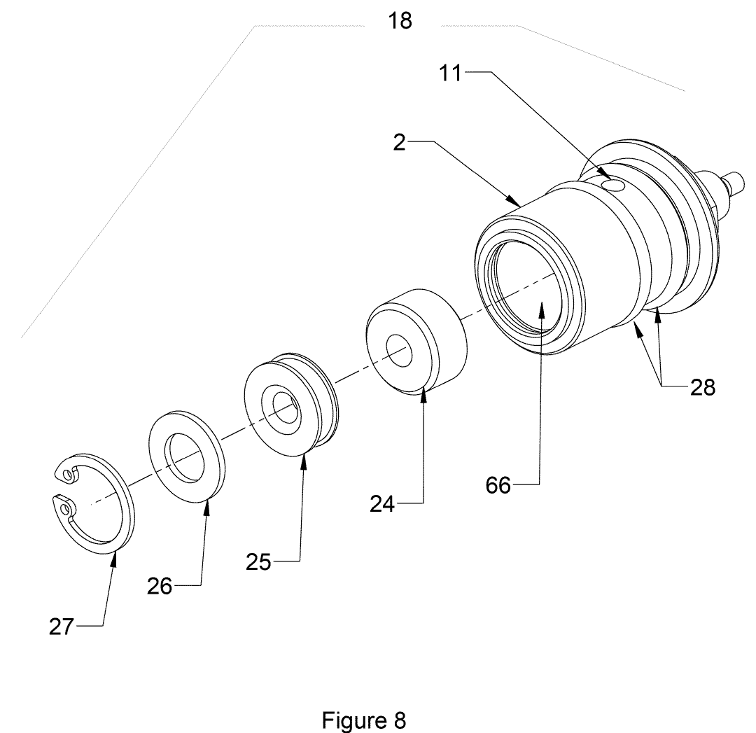

Reference is now additionally made to FIG. 8 which shows an exploded isometric view of the nozzle liquid tip assembly 18. A needle guide bushing 24 is provided on one side of the needle liquid seal 25 (and is preferably positioned on the side closer to the fluid opening at the end of the nozzle liquid tip 2 so that the greatest distance can be achieves between the needle guide bushing 24 and the liquid metering tip base 7 thus providing the most stability and accurate orientation of the liquid metering needle. The needle guide bushing 24 guides the liquid metering needle 4 inside the nozzle liquid tip assembly 18 so that the liquid metering needle 4 remains true and centered relative to the opening at the end of the nozzle liquid tip 2. A washer 26 is provided on the other side of the needle liquid seal 25. A retaining ring 27 functions to retain the needle guide bushing 24, needle liquid seal 25 and washer 26 within the central bore of the nozzle liquid tip 2. The retention may provide some compression of the needle liquid seal 25 so as to assist in ensuring that both the slidable seal with respect to the liquid metering needle 4 and the static seal with respect to the central bore of the liquid tip 2 are maintained.

The assembly 18 provides for a single replacement part that allows an operator to easily replace worn seals and guide bushings, all incorporated into the nozzle tip.

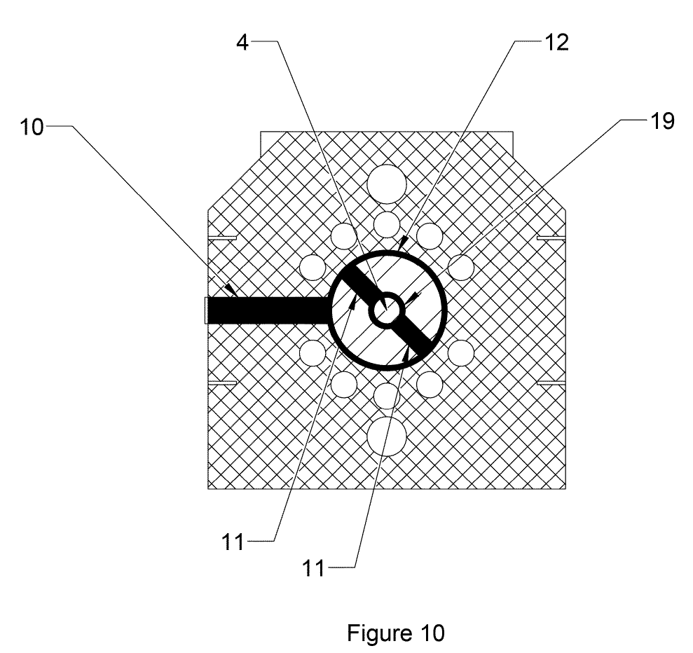

Reference is now made to FIG. 9 which illustrates a cross-sectional view of a nozzle assembly 1 in a valve open position. Thus, the needle actuator pin 8 has been moved backward (i.e., in a direction away from the nozzle liquid tip assembly 18) causing the liquid metering needle 4 to also move backward. The valve is thus opened in the nozzle liquid tip assembly 18 permitting liquid provided to the nozzle assembly 1 through the liquid inlet port 10 to be released from the fluid exit path 19 within the central bore of the nozzle liquid tip 2. Thus, liquid enters the nozzle housing 3 through liquid inlet port 10, fills up and flows around the annular liquid path 12 that is created between the two nozzle liquid tip o-rings 28, passes through portion 11, flows around the liquid metering needle 4 within the fluid exit path 19 and is released from the opening at the end of the nozzle liquid tip 2 (with a spray emitted from the air cap atomizing port 20). FIG. 10 shows a front cross sectional view of the nozzle assembly 1 and the fluid path as described above.

In summary, operation of the nozzle is as follows: pressurized air flows around the nozzle liquid tip 8 from the openings 22 and passes through the air cap 5 at the air cap atomizing port 20 to atomize fluid that is released by the valve mechanism provided in the at the nozzle liquid tip 2. The ports for carrying the pressurized air through the nozzle housing 3 to the openings 22 and 23 are not shown in FIGS. 1 and 9, but the configuration of such air ports is well known to those skilled in the art. The ports can be seen in the cross-section of FIG. 10 and these ports may, in a preferred implementation, be plumbed to a common port connection on the side of the nozzle assembly 1. If desired, a separate plumbing connection and port connection for atomizing air and shaping air could be provided. The pressurized air further flows from the openings 21 and 23 to define the shape of the resulting spray pattern. When the needle actuator pin 8 is pulled back, this will in turn pull back the liquid metering needle 4 from a sealing surface position with respect to the tapered end of the central bore in the nozzle liquid tip 2. When the needle 4 is pulled back, this allows liquid to flow through the liquid inlet port 10 and into the central bore 66 of the nozzle liquid tip 2 through the internal liquid ports 11. To reach the nozzle tip liquid ports 11, the liquid will flow through and around the annular liquid path 12 that is formed by the empty space created between the two nozzle liquid tip o-rings 28. Once the liquid is in the nozzle liquid tip 2, it flows around liquid metering needle 4 and exits from the opening 64 at the end of the nozzle liquid tip 2 where it is atomized by the pressurized air flowing around the nozzle liquid tip 8 from the openings 22 and passing through the air cap 5 at air cap atomizing port 20 as an atomized liquid spray. The pressurized air from the air cap pattern shaping ports 21 is then used to shape the atomized liquid spray.

Although not specifically illustrated, the nozzle assembly 1 could be configured to support electrostatic spraying. For example, an induction charging node, with an appropriate electrical connection, could be positioned at or near the air cap atomizing port 20.

The nozzle described above provides a number of benefits including:
A nozzle tip that incorporates the needle seal and needle guide into one assembly that is removable from the front of the nozzle so as to provide for an easy and efficient way of replacing and cleaning the critical parts of the sprayer
A needle guide that is positioned towards the end of the needle to provide more stability and accuracy than traditional designs.
The ability to remove the needle tip, and other components of the nozzle, from the front of the nozzle to provide for an easy and efficient way to support cleaning and replacement.
The annular liquid path created by the two o-rings on the nozzle tip assembly eliminates the need for any specific angular orientation between the nozzle tip and the nozzle body in order to line up the mating fluid pathways.
This design also provides for a more compact assembly.

What is claimed is:

1. A spray nozzle, comprising:
a nozzle housing having a first bore and a first liquid inlet passing through the nozzle housing and opening into the first bore;
a nozzle liquid tip assembly inserted into the first bore and removably attached to the first bore, the nozzle liquid tip assembly including a liquid tip having a second bore and a second liquid inlet passing through the liquid tip and opening into the second bore;
a first annular sealing member positioned between an outer surface of the liquid tip and the first bore at a first location behind both the second liquid inlet and the nozzle housing opening into the first bore; and
a second annular sealing member positioned between the outer surface of the liquid tip and the first bore at a second location ahead of both the second liquid inlet and the nozzle housing opening into the first bore;
wherein the first and second annular sealing members define an annular fluid path coupling the first liquid inlet to the second liquid inlet.

2. The spray nozzle of claim 1, wherein the nozzle liquid tip assembly further comprises a needle liquid seal member inserted and retained within the second bore of the liquid tip.

3. The spray nozzle of claim 2, further comprising a liquid metering needle inserted through an opening of the needle liquid seal member and into the second bore of the liquid tip.

4. The spray nozzle of claim 3, wherein said liquid metering needle is axially movable and the needle liquid seal member forms a sliding seal against said axially movable liquid metering needle.

5. The spray nozzle of claim 4, wherein said needle liquid seal member further forms a static seal against an inside surface of the liquid tip which is defined by said second bore.

6. The spray nozzle of claim 4, wherein the liquid tip of the nozzle liquid tip assembly further comprises a front opening, and further comprising an actuating mechanism configured to axially move said liquid metering needle between a first position where the liquid metering needle closes the front opening of the liquid tip and a second position where the liquid metering needle opens the front opening of the liquid tip.

7. The spray nozzle of claim 6 wherein the actuating mechanism comprises a spring configured to bias positioning of the liquid metering needle at said first position.

8. The spray nozzle of claim 3, wherein the nozzle liquid tip assembly further comprises a needle guide bushing member inserted and retained within the second bore of the liquid tip, said liquid metering needle being inserted through an opening of the needle guide bushing member and into the second bore of the liquid tip.

9. The spray nozzle of claim 8, wherein the nozzle liquid tip assembly further comprises a retaining ring inserted into the second bore of the liquid tip and configured to retain the needle liquid seal member and needle guide bushing member within the nozzle liquid tip assembly.

10. The spray nozzle of claim 8, wherein the liquid tip of the nozzle liquid tip assembly further comprises a front opening, said opening of the needle guide bushing member configured to align the liquid metering needle with the front opening.

11. The spray nozzle of claim 3, wherein the liquid tip of the nozzle liquid tip assembly further comprises a front opening, said liquid metering needle when inserted into the second bore of the liquid tip being adapted to selectively close said front opening.

12. The spray nozzle of claim 3, further comprising an actuating mechanism configured to axially move said liquid metering needle, said liquid metering needle being removably attached to the actuating mechanism.

13. The spray nozzle of claim 12, wherein the actuating mechanism comprises a liquid metering tip base to which a back end of the liquid metering needle is removably attached.

14. The spray nozzle of claim 13, wherein the actuating mechanism comprises an actuating pin configured to actuate axial movement of the liquid metering tip base.

15. The spray nozzle of claim 14, wherein the first bore of the nozzle housing further comprises a needle base guide pocket, further comprising a spring installed within the needle base guide pocket in a position to provide a biasing force against the liquid metering tip base.

16. A spray nozzle, comprising:
a nozzle housing having a first bore and a liquid inlet path;
a nozzle liquid tip positioned within the first bore;
an annular fluid path between the nozzle liquid tip and the nozzle housing and surrounding the nozzle liquid tip, the annular fluid path configured to receive fluid from the liquid inlet path; and
the annular fluid path fluidly coupled to a liquid inlet of the nozzle liquid tip.

17. The spray nozzle of claim 16, wherein the nozzle liquid tip defines at least one nozzle tip liquid port fluidly coupled to the annular fluid path, and further comprising a plurality of o-rings forming seals between the nozzle housing and the nozzle liquid tip, the plurality of o-rings further defining the annular fluid path.

18. A spray nozzle, comprising:
a nozzle housing having an aperture configured to receive an air cap;
an air cap retaining ring configured to removably secure the air cap within the aperture of the nozzle housing;
wherein the nozzle housing includes a first bore; and
a nozzle liquid tip assembly defining a fluid path, said nozzle liquid tip assembly being removably secured within the first bore;
wherein the nozzle liquid tip assembly is removable from the first bore as a self-contained assembly following removal of the air cap retaining ring and air cap.

19. The spray nozzle of claim 18, further comprising an annular fluid path defined between an outer surface of the nozzle liquid tip assembly and the first bore of the nozzle housing.

20. The spray nozzle of claim 19, wherein the annular fluid path is defined between a pair of annular sealing ring members positioned between the outer surface of the nozzle liquid tip assembly and the first bore of the nozzle housing.

21. The spray nozzle of claim 20, wherein the nozzle liquid tip assembly includes a second fluid bore, and further comprising a liquid metering needle positioned within the second fluid bore.

22. The spray nozzle of claim 21, wherein the liquid metering needle is removable from the first bore following removal of the air cap retaining ring, the air cap and the nozzle liquid tip assembly.

23. The spray nozzle of claim 21, wherein the nozzle liquid tip assembly includes a nozzle liquid tip defining the second fluid bore having a front end and a back end, the front end including a fluid outlet adapted to emit fluid for atomization; and
a needle liquid seal secured within the second fluid bore adjacent the back end, said needle liquid seal configured to slidably seal around said liquid metering needle.

24. The spray nozzle of claim 23, wherein said needle liquid seal is further configured to statically seal against the second fluid bore of the nozzle liquid tip.

25. The spray nozzle of claim 24, wherein the nozzle liquid tip assembly further includes a needle guide bushing secured within the second fluid bore adjacent the needle liquid seal, said needle guide bushing configured to align the liquid metering needle with the fluid outlet adapted to emit fluid for atomization.

26. The spray nozzle of claim 25, wherein the needle guide bushing and needle liquid seal are retained in the second fluid bore with a relative positioning where the needle guide bushing is closer to the front end including the fluid outlet than the needle liquid seal.
